(19) United States
(12) Patent Application Publication
(10) Pub. No.: US 2026/0292570 A1
(43) Pub. Date: Sep. 24, 2026

(54) MULTIPLE MEASUREMENT REPORT CONFIGURATIONS FOR DIFFERENT HEIGHTS

(71) Applicant: Apple Inc., Cupertino, CA (US)

(72) Inventors: Yuqin CHEN, Beijing (CN); Fangli XU, Beijing (CN); Ping-Heng KUO, London (GB); Peng CHENG, Beijing (CN); Naveen Kumar R. PALLE VENKATA, San Diego, CA (US); Ralf ROSSBACH, Munich (DE); Sethuraman GURUMOORTHY, San Ramon, CA (US); Haijing HU, Los Gatos, CA (US); Qiming LI, Beijing (CN); Alexander SIROTKIN, Hod Hasharon (IL)

(21) Appl. No.: 19/473,452

(22) PCT Filed: Apr. 7, 2023
(86) PCT No.: PCT/CN2023/086961

§ 371 Date: Oct. 7, 2025

(51) Int. Cl. H04W 24/10

(52) U.S. Cl. CPC H04W 24/10

(57) ABSTRACT

User equipment (UE) in a 5G new radio (NR) environment may be configured to receive a radio resource management (RRM) information from a network. The RRM information may comprise a height event that is associated with a height range and a signal quality event that is associated with said height range. The UE may perform a measurement of the network based on a current height of the UE and the RRM information. In response to at least the height event and the signal quality event being satisfied, the UE may generate a measurement report and sending the measurement report to the network. Other aspects are described.

### FIELD OF INVENTION

This invention relates generally to wireless technology and more particularly to communications involving multiple measurement report configurations for different heights.

### BACKGROUND OF THE INVENTION

Fifth generation mobile network (5G) is a wireless standard that aims to improve upon data transmission speed, reliability, availability, and more. The wireless standard includes numerous procedures that may be implemented by a transmitting device or a receiving device that improves the latency, the speed, and the reliability of uplink and downlink transmissions.

### SUMMARY OF THE DESCRIPTION

Aspects of the present disclosure relate to 5G new radio (NR) operating in the licensed spectrum or in the shared and unlicensed spectrum (NR-U).

In one aspect, a method performed by a user equipment (UE) in a 5G new radio (NR) environment, comprises receiving a radio resource management (RRM) information from a network, the RRM information comprising a height event that is associated with a height range and a signal quality event that is associated with said height range; performing a measurement of the network based on a current height of the UE and the RRM information; and in response to at least the height event and the signal quality event being satisfied, generating a measurement report and sending the measurement report to the network. Various examples are described with this aspect.

In one example, the RRM information comprises a first measurement identifier (ID) and a second measurement ID. The first measurement ID is associated with a measurement object ID and a first report configuration ID comprising the height event and an association with the second measurement ID. The second measurement ID is associated with said measurement object ID and a second report configuration comprising the signal quality event and a second association with the first measurement ID.

In one example, the RRM information comprises a single measurement ID comprising a measurement object ID, a first report configuration ID comprising the height event, and a second report configuration ID comprising the signal quality event.

In one example, the RRM information comprises a single measurement ID comprising a measurement object ID and a first report configuration ID, wherein the first report configuration ID comprises the height event and an association to a second report configuration ID that comprises the signal quality event.

In one example, the RRM information comprises a measurement object, and a report configuration, wherein the report configuration comprises i) a first configuration comprising the height event and the signal quality event, and ii) a second configuration comprising a second height event and a second signal quality event.

In one example, the RRM information comprises a measurement object ID that comprises a plurality of height ranges and corresponding reference signal to measure for a respective one of the plurality of height ranges.

In one example, performing the measurement of the network based on the current height of the UE and the RRM information comprises determining that the RRM information comprises i) a first measurement ID comprising the height event and ii) a second measurement ID comprising the signal quality event.

In one example, the RRM information comprises a time to trigger for the height event and a second time to trigger for the signal quality event. In one example, the RRM information comprises a number of triggering cells associated with the height event or with the signal quality event.

In one example, to determine that the height event and the signal quality event are satisfied the UE may independently determine that i) the height event is satisfied for a first time to trigger, and ii) the signal quality event is satisfied for a second time to trigger.

In one example, determining that the height event and the signal quality event are satisfied comprises determining that i) the signal quality event is satisfied for a first time to trigger, and ii) the height event is satisfied instantaneously without a second time to trigger.

In one example, determining that the height event and the signal quality event are satisfied comprises determining that one of the signal quality event or the height event satisfies a first time to trigger, and in response to the one satisfying the first time to trigger, determining another of the signal quality event or the height event satisfies a second time to trigger.

In one example, in response to the UE leaving the height range, the UE clears a layer 1 sample associated with the measurement of the network associated with the height range. Similarly, in response to the UE leaving the height range, the UE does not clear layer 3 measurements of the network. Additionally, or alternatively, in response to the UE leaving the height range, the UE re-evaluates if cells that previously satisfied a respective signal quality event and respective height event still satisfy the respective signal quality event and respective height event. In one example, in response to the UE leaving the height range, the UE clears any cell that previously satisfied a respective signal quality event and height event.

In one example, the method includes sending, to the network, an indication of a reference signal that the UE is currently measuring, wherein the network schedules around the reference signal in response to receiving the indication from the UE. Sending the indication may comprise sending a measurement object ID with a reference signal index or a height range index in a media access control (MAC) control element (CE) signal.

In one aspect, a method performed by a network in a 5G new radio (NR) environment, comprises sending a radio resource management (RRM) information to a user equipment (UE), the RRM information comprising a height event that is associated with a height range and a signal quality event that is associated with said height range, wherein the UE is configured to perform a measurement of the network based on a current height of the UE and the RRM information, and in response to the height event and the signal quality event being satisfied, generate a measurement report and send the measurement report to the network; and receiving the measurement report from the UE.

Other aspects are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some aspects.

FIG. 2 illustrates uplink and downlink communications according to some aspects.

FIG. 3 illustrates an example block diagram of a UE according to some aspects.

FIG. 4 illustrates an example block diagram of a BS according to some aspects.

FIG. 5 illustrates an example block diagram of cellular communication circuitry, according to some aspects.

FIG. 6 illustrates an example of a UE in a multi-height network environment, according to some aspects.

FIG. 7 illustrates an example of configuration information that may be provided from a network to a UE for multiple heights with association between measure IDs, according to some aspects.

FIG. 8 illustrates an example of configuration information that may be provided from a network to a UE for multiple heights where a measure ID is associated with multiple report configurations, according to some aspects.

FIG. 9 illustrates an example of configuration information that may be provided from a network to a UE for multiple heights where a report configuration includes an association to a second report configuration, according to some aspects.

FIG. 10 illustrates an example of configuration information that may be provided from a network to a UE for multiple heights where a report configuration includes multiple triggering information, according to some aspects.

FIG. 11 shows an example diagram of independent event triggering, according to some aspects.

FIG. 12 shows an example diagram of joint event triggering, according to some aspects.

FIG. 13 shows an example diagram of subsequent event triggering, according to some aspects.

### DETAILED DESCRIPTION

A method and apparatus of a device that communicates wirelessly with a network to obtain or use network configuration information at different heights is described. In the following description, numerous specific details are set forth to provide thorough explanation of aspects of the present invention. It will be apparent, however, to one skilled in the art, that aspects of the present invention may be practiced without these specific details. In other instances, well-known components, structures, and techniques have not been shown in detail in order not to obscure the understanding of this description.

Reference in the specification to “some aspects” or “an aspect” means that a particular feature, structure, or characteristic described in connection with the aspect can be included in at least one aspect of the invention. The appearances of the phrase “in some aspects” in various places in the specification do not necessarily all refer to the same aspect.

In the following description and claims, the terms “coupled” and “connected,” along with their derivatives, may be used. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device may provide enhanced operation for situations where a user equipment (UE) device is to move between various heights or height ranges. At different heights, considerations may be taken as to how to perform network measurements to connect to a proper cell. For example, at a given height, the UE may sense a different number of cells, or sense the signal strength of each cell different from at another height. Further, the index of a reference signal (e.g., a beam) from a given cell may differ depending on the UE height.

In some aspects of the present disclosure, a UE may be integral to an unmanned air vehicle (UAV) or other aircraft, and may undergo such changes in height (e.g., altitude) frequently. In some aspects, the device is a user equipment device that has a wireless link with a base station (e.g., a serving cell). In some aspects, the wireless link is a fifth generation (5G) link.

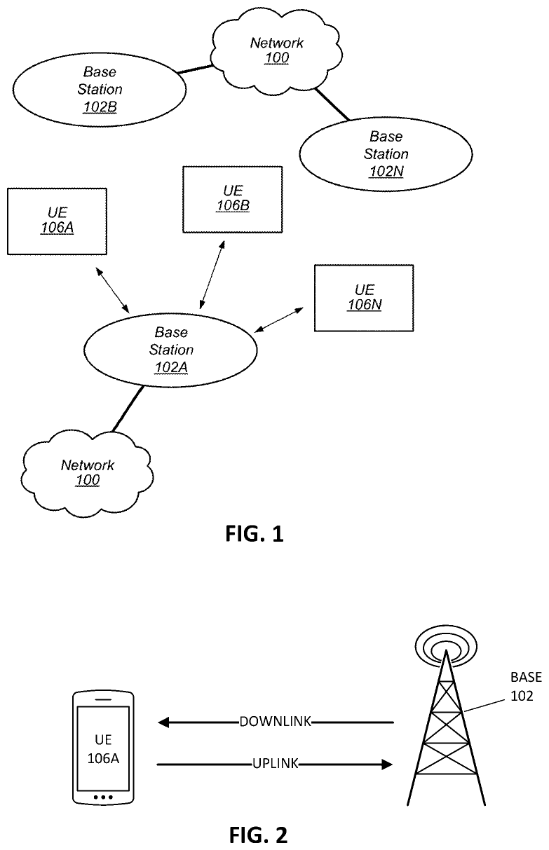

FIG. 1 illustrates a simplified example wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to as a “user equipment” (UE).

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP 2 CDMA 2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP 2 CDMA 2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates UE 106A that can be in communication with a base station 102 through uplink and downlink communications, according to some aspects. The UEs may each be a device with cellular communication capability such as a mobile phone, a hand-held device, a computer or a tablet, or virtually any type of wireless device.

The UE may include a processor that is configured to execute program instructions stored in memory. The UE may perform any of the method aspects described herein by executing such stored instructions. Alternatively, or in addition, the UE may include a programmable hardware element such as an FPGA (field-programmable gate array) that is configured to perform any of the method aspects described herein, or any portion of any of the method aspects described herein.

The UE may include one or more antennas for communicating using one or more wireless communication protocols or technologies. In some aspects, the UE may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE may include separate transmit and/or receive chains (e.g., including separate antennas and other radio components) for each wireless communication protocol with which it is configured to communicate. As a further possibility, the UE may include one or more radios which are shared between multiple wireless communication protocols, and one or more radios which are used exclusively by a single wireless communication protocol. For example, the UE might include a shared radio for communicating using either of LTE or 5G NR (or LTE or 1xRTT or LTE or GSM), and separate radios for communicating using each of Wi-Fi and Bluetooth. Other configurations are also possible.

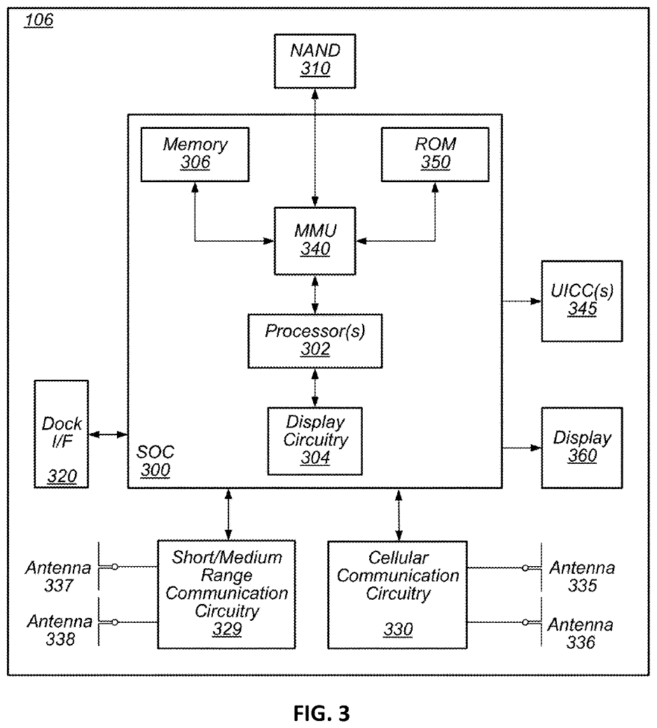

FIG. 3 illustrates an example simplified block diagram of a communication device 106, according to some aspects. It is noted that the block diagram of the communication device of FIG. 3 is only one example of a possible communication device. According to aspects, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

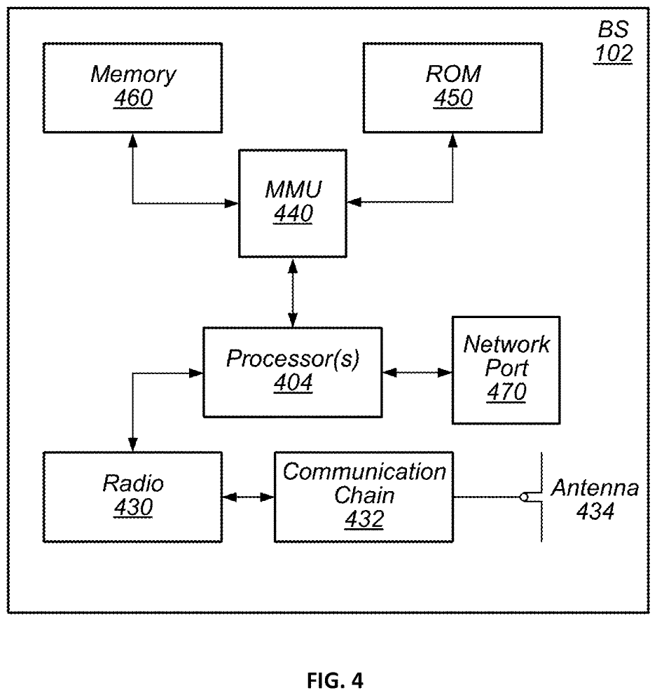

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs. In some aspects, the base station can operate in 5G NR-U mode.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, 5G NR-U, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR and 5G NR-U. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

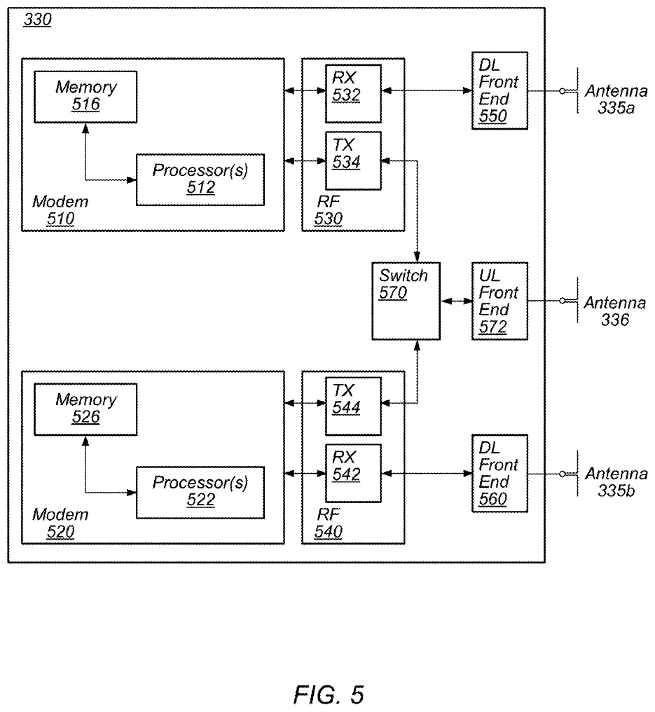

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some aspects, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for determining a physical downlink shared channel scheduling resource for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining a physical downlink shared channel scheduling resource for a user equipment device and a base station, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G supports multi-antenna transmission, beam-forming, and simultaneous transmission from multiple geographically separates sites. Channels of different antenna ports that are relevant for a UE may differ, for example, in terms of radio channel properties. QCL antenna port may be geographically separated.

5G physical channels provide flexible communication between the 5G base stations and the UEs. 5G NR has specified the physical channels for 5G networks that can be used either for Downlink or Uplink communication. 5G NR physical channels used for uplink communication includes the physical uplink shared channel (PUSCH), the physical uplink control channel (PUCCH), and the physical random-access channel (PRACH). Uplink signals such as DM-RS, PT-RS, and SRS are also supported. 5G NR supports the simultaneous transmission on PUSCH and PUCCH. PUSCH is typically used to carry the user data and optionally, can carry uplink control information (UCI).

In 5G, a UE may be integral to a vehicle such as an unmanned air vehicle (UAV) or other kind of vehicle. A UE may travel from the ground to varying heights. Various issues relating to 5G communications in such a situation remains unresolved.

For example, one issue relates to downlink (DL) and uplink (UL) interference detection. In this regard, a UE may report on Reference Signal Received Power (RSRP), Received Signal Strength Indication (RSSI), and/or Signal Interference+Noise Ratio (SINR), which may be utilized for interference detection. Measurement reporting can be enhanced.

A second issue relates to downlink interference mitigation. Multiple Input Multiple Output (MIMO) beamforming related solutions have been studied, but no solution has been agreed upon.

Under the Long Term Evolution (LTE) solution, UEs perform measurement triggering based on the detected number of cells satisfying a threshold number. The network (NW) indicates to the UE, the number of cells (numberOfTriggeringCells) detected that are required to fulfill an event for a measurement report to be triggered. The protocol may support ReportOnleave-when the cell does not meet the A3/A4/A5 event entry condition. A UE may be configured to only initiate the reporting when the number of detected cells is larger or equal to numberOfTriggeringCells as provided by the NW.

Enhanced operation relating to UEs in multi-height conditions (e.g., UAVs) are described with respect to some aspects of the present disclosure. Enhancements on measurement reports may include UE-triggered measurement report based on configured height thresholds, reporting of height, location and speed in measurement report, flight path reporting, and measurement reporting based on a configured number of cells (i.e., larger than one) fulfilling the triggering criteria simultaneously.

In some enhancements, the signaling to support subscription-based aerial-UE identification may be specified. Enhancements for UAV identification broadcast may be described.

Aspects described in the present disclosure may be applicable to long term evolution (LTE), new radio (NR), or both. Enhancements may incorporate existing techniques based on Uu or non 3GPP technologies, or unlicensed band as the baseline.

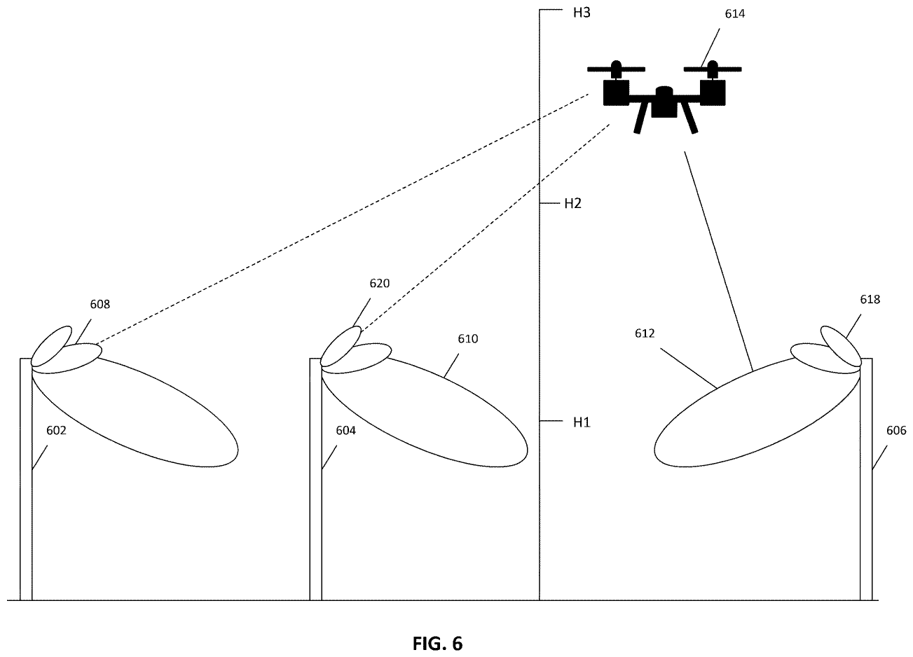

FIG. 6 illustrates an example of a UE 604 in a multi-height network environment, according to some aspects. UE 604 may include or be integral to an unmanned air vehicle (UAV). A UE 604 and network may be configured to support multiple configurations for different height ranges (e.g., height H1, H2, H3, etc.). A network may comprise one or more cell towers such as cell tower 602, 604, and 606.

At different heights, the signal strength measurement (e.g., RSRP) of a neighbor cell as detected by UE 614 may vary. For example, UE 614 may be camped on cell 606. The RSRP of neighbor cell 604 at height H1 may be measured as ‘x’. As UE 614 ascends to height H2, the RSRP of neighbor cell 604 may improve to ‘y’. Similarly, the number of cells that UE 614 detects may also vary depending on height. For example, at height H1, UE may be camped on cell 606 and detect one other cell 604. At height H2, UE 614 may detect cell 604 and 602.

At different height, UE 614 may sense different reference signal indices (e.g., different beams) from serving and neighbor cells. For example, at range H1, UE 614 may best sense beam 612 from serving cell 606 and beam 622 from neighbor cell 604. UE 614 may not sense cell 602 at H1. At height H3, UE 614 may best sense beam 618 from the same serving cell 606, and beam 620 from neighbor cell 604. Further, at height H3, the UE 614 may sense neighbor cell 602 (where it could not at lower heights) and measure beam 608. Due to the different network characteristics at different heights, several issues may arise.

One such issue is how to enable multiple resource radio management (RRM) configurations. Radio Resource Management (RRM) in 5G networks refers to the process of effectively managing and allocating available radio resources, including frequency spectrum, time, and power, to optimize the overall network performance and enhance the user experience. Key aspects of RRM in 5G networks include Dynamic Spectrum Management, Beamforming and Massive MIMO, Quality of Service (QOS) Management, Interference Management, Dynamic Resource Allocation, and Dynamic Spectrum Management.

Beamforming and Massive MIMO include technologies that use advanced antenna arrays and signal processing techniques to optimize the use of radio resources by focusing energy on the direction of the intended user (e.g., the UE), thereby improving the signal quality and reducing interference. RRM in 5G networks uses QOS parameters to manage and prioritize traffic based on user requirements and application needs. This ensures that critical applications such as video conferencing and emergency services get the required network resources. 5G RRM uses techniques such as Interference Avoidance (IA), Interference Coordination (IC), and Interference Management (IM) to minimize the effects of interference and improve network efficiency. 5G RRM dynamically allocates resources to meet changing network demands, using techniques such as Dynamic Channel Assignment (DCA), Power Control (PC), and Resource Block (RB) allocation. Such 5G RRM techniques provide efficient and reliable operation of 5G networks by optimizing the use of available resources and providing a better user experience.

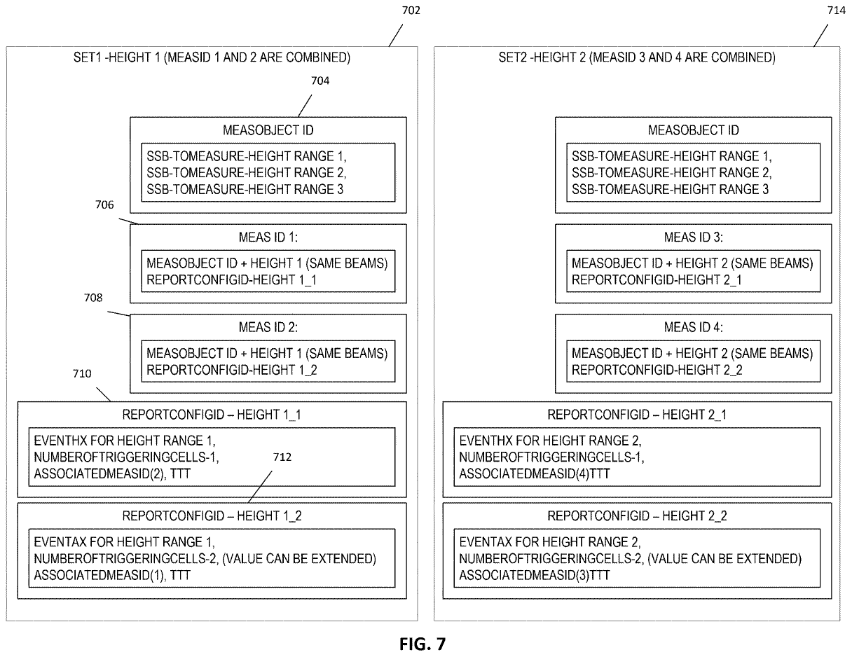

In one aspect, the UE 614 may receive a radio resource management (RRM) information from a network, the RRM information comprising a height event that is associated with a height range and a signal quality event that is associated with said height range. For example, the serving cell 606 may send the RRM information to the UE through radio resource control (RRC) signaling. The RRM information may be organized as discussed in other examples (e.g., as described in FIG. 7-10).

The UE may perform a measurement of the network based on a current height of the UE and the RRM information. For example, the RRM information may specify an SSB index (or other reference signal) corresponding to beam 618 at a given frequency for height range H3 for cell 606. The UE may take a measurement (e.g., RSRP, RSRQ) of the signal strength of the beam.

In response to the height event and the signal quality event being satisfied, the UE may generate a measurement report and send the measurement report to the network.

Regarding the height event and the signal quality event, these may be predefined triggering events. For example, in telecom technology, mobility decision such as whether a UE will be handover to a neighbor cell may be determined based on measurement reports from the UE. There are multiple measurement items (RSRP, RSRQ, SINR) and which may be triggered periodically or based on an event, to measure the signal quality of the serving cell and neighbor cells. 3GPP specifications include a set of predefined set of measurement report mechanism to be performed by UE. These predefined measurement report types may be referred to as an “Event”. The type of “event” a UE is to report may be specified in the RRM information by RRC signaling message sent to the UE by the network (e.g., the serving cell). 3GPP specification 38.331(5.5.4.2 -5.5.4.7) includes various signal quality events including: Event A1 is triggered when the serving cell becomes better than threshold. It may be used to cancel an ongoing handover procedure. Event A2 is triggered when serving cell becomes worse than threshold. Event A2 may be used to trigger a mobility procedure when a UE moves towards cell edge. Event A2 does not involve any neighbor cell measurements so it may be used to trigger a blind mobility procedure. Event A3 is triggered when a neighbor cell becomes better than a special cell (SpCell) by an offset. A special cell is the primary serving cell of either the Master Cell Group (MCG) or Secondary Cell Group (SCG)). The offset can be either positive or negative. Event A4 is triggered when neighbor cell becomes better than defined threshold. This event can be used for handover procedures which does not depend upon the coverage of the serving cell. Event A5 is triggered when a special cell becomes worse than a first threshold, while a neighboring cell becomes better than a second threshold. Event A6 is triggered when a neighbor cell becomes better than a secondary cell by an offset. The offset can be either positive or negative. Thus, the signal quality event may comprise any such events A1-A6, which may also be referred to as AX.

Similarly, the height event may be a height range (e.g., an altitude range) such as, for example, H1, H2, etc. Thus, the UE may measure the signal quality of a cell to determine if the signal quality event, and check its current height (e.g., with GPS or other sensor) to determine if the height event is satisfied. If both are satisfied, the UE may trigger a measurement report operation which may include taking one or more additional measurements, generating the measurement report with the measurement data, and sending the measurement report to the network (e.g., to the serving cell or a neighbor cell).

The network may provide different criteria (e.g., different signal quality event and different height event) for each height range. Other criteria may also be provided per height range. For example, the RRM information may specify the time to trigger for each event, whether the event is a height event or a signal quality event. Further, the RRM information may include a number of triggering cells that the UE senses in order to trigger the measurement report. A UE may initiate the measurement reporting if the number of cells in a cellsTriggeredList is larger than or equal to the specified number of triggering cells. The RRM information may also comprise a measurement object that includes all the different height ranges and corresponding reference signal to measure (e.g., an SSB index or CSI-RS index) for that height range for a given cell.

For example, it may be desirable to configure UE at height range H1, so that UE 614 triggers a measurement report based on a specified signal strength measurement (e.g., an AX-1 event-1), with numberOfTriggeringCells-1, SSB index to measure, and/or CSI-RS resources to measure. Similarly, at height range H2, UE 614 may be configured to trigger a measurement report based on a different set of RRM information such as AX-2 event-2, with numberOfTriggeringCells-2, SSB index to measure, and CSI-resources to measure. Similarly, at height range H3, a UE may be configured with AX-3 event-3, numberOfTriggeringCells-3, SSB index to measure, CSI-RS resources to measure, and so on. Thus, the UE may be configured with different triggering events and other network information for each height. The network may configure the UE so that the number of triggering cells increases as the height range increases. Other examples are described.

Another issue is how the UE should behave when its height changes to another range, to best accommodate for the different network characteristics. For example, when UE height changes, UE may determine whether the previously collected network samples which correspond to unintended beams should be kept. Similarly, UE may determine whether the network should know which height the UE is in, for the network to perform best scheduling restriction. The reasoning is that the Synchronization Signal Block (SSB)-ToMeasure would be changed and, as a result, scheduling restriction would be changed as well. As described, other configurations such as time to trigger (TTT), layer 3 (L3) measurement filter, and other operations or measurements can be also different for different height ranges.

As discussed, at least three issues are recognized and addressed in aspects of the present disclosure. The first issue relates to supporting multiple Radio Resource Management (RRM) configurations to UE for multiple height ranges. One of the key considerations for the first issue is how to associate two or more report events. A second issue relates to UE behavior once height change on previously collected samples. A third issue relates to coordination of beam indexes between UE and network. With this third issue, a first option includes that the network uses the union of configured SSB-ToMeasure(s) for scheduling determination without coordination. In a second option, to improve scheduling at network, the UE may send a MAC CE once the measured beam index(s) are changed due to the UE height change. Additionally, or alternatively, the height range of the UE may can be extended to include a more specific 3D location (Latitude, Longitude, and/or Height) of the UE.

FIG. 7 illustrates an example of configuration information that may be provided from a network to a UE for multiple heights with association between measure IDs, according to some aspects. FIG. 7 shows two sets of RRM configuration data that may be provided from the network to the UE through RRM signaling, in some examples. Such signaling may support multiple RRM configurations to UE for multiple height ranges with signaling that associates two or more report events with each other.

As described, the network may provide the UE with RRM information such as 702 which may be a first set of RRM information corresponding to a first height range. The network may also provide the UE with one or more additional RRM information such as 714 which may be referred to as a second set of RRM information that corresponds to a second height range.

Each set such as set 1 and set 2 may include two reporting triggers, eventAX and eventHX, for a given height range. Multiple sets are identified with multiple MeasID(s). Each MeasID associates with one reportConfig and also associates with the same MeasObject. In MeasObject, multiple SSB-ToMeasure are configured for multiple height ranges. For each reporting with one certain height range, UE refers to the corresponding SSB-ToMeasure set. A ‘MEAS ID’ may be referred to as a measurement ID. A ‘MEASOBJECT ID’ may be referred to as a measurement object ID. A ‘REPORTCONFIGID’ may be referred to as a report configuration ID. ‘EVENTHX’ may refer to a measurement event relating to height, and ‘EVENTAX’ may refer to a measurement event such as measurement events A1, A2, A3, A4, A4, A5, or A6, which may relate to measuring signal quality of the network. The signal quality of the network may include a signal quality measurement of a neighbor cell, the serving cell, a special cell, or a combination thereof.

Each set also includes an association between measID(s). The UE may provide signaling with the associated measID (#1) added into the ReportConfig of the other measID (#2). In this manner, the UE may receive multiple linked report configuration IDs that specify a height event (e.g., EVENTHX) and a signal quality event (e.g., EVENTAX) for the height range associated with set 702.

For example, the RRM information (e.g., set 702) may comprise a first measurement ID 706 and a second measurement ID 708. The first measurement ID 706 may be associated with a measurement object ID 704 and a first report configuration ID 710 comprising the height event and an association with the second measurement ID 708. This association may be an indication (e.g., an identifier, a value, or other indicator) such as ‘ASSOCIATEDMEASID(2)’ that links the report configuration 710 to the second measurement ID 708.

Similarly, the second measurement ID may be associated with said measurement object ID 704 (e.g., the same measurement object ID) and a second report configuration ID 712 comprising the signal quality event and a second association with the first measurement ID 708. This second association may also be an indication (e.g., an identifier, a value, or other indicator) such as ‘ASSOCIATEDMEASID(1)’ that links the second report configuration 712 to the first measurement ID 706.

Additional RRM information such as 714 may be sent from the network to the UE to configure the UE to perform measurement reports. At each height range, the UE may use the corresponding parameters provided in the corresponding set of RRM information.

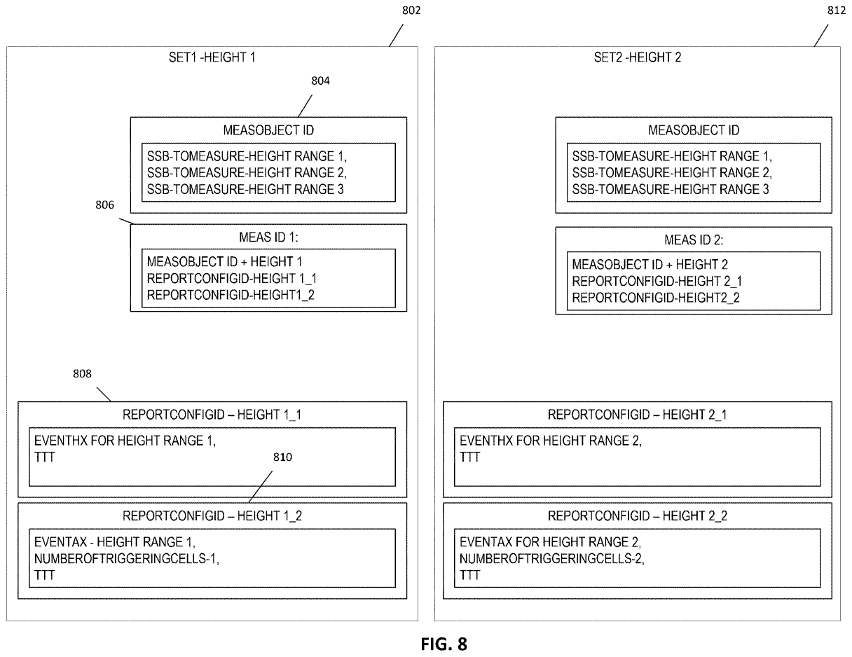

FIG. 8 illustrates an example of configuration information that may be provided from a network to a UE for multiple heights where a measure ID is associated with multiple report configurations, according to some aspects. FIG. 8 shows two sets of RRM configuration data that may be provided from the network to the UE through RRM signaling, in some examples. Such signaling may support multiple RRM configurations to UE for multiple height ranges with signaling that associates two or more report events with each other.

In FIG. 8, multiple sets combine two reporting triggers. One measurement ID may include one measurement object and multiple report configuration IDs. For a measurement object, the UE may select the corresponding SSB-ToMeasure based on the height configured in ReportConfig as received from the network.

For example, the RRM information (e.g., 802) may comprise a single measurement ID 806. This single measurement ID 806 may include a reference to measurement object ID 804, a first report configuration ID 808 comprising the height event, and a second report configuration ID 810 comprising the signal quality event. As in other examples, measurement object ID describes a reference signal (e.g., SSB, CSI-RS, or other reference signal) for the UE to measure at a given height range. Further, as in other examples, the report configuration ID (e.g., 808 and 810) may comprise additional information such as, for example, time to trigger, number of triggering cells, or both.

The structure of set 802 may be replicated with different RRM information corresponding to a different height. For example, set 812 may comprise the same structure but different height event or signal quality event requirements.

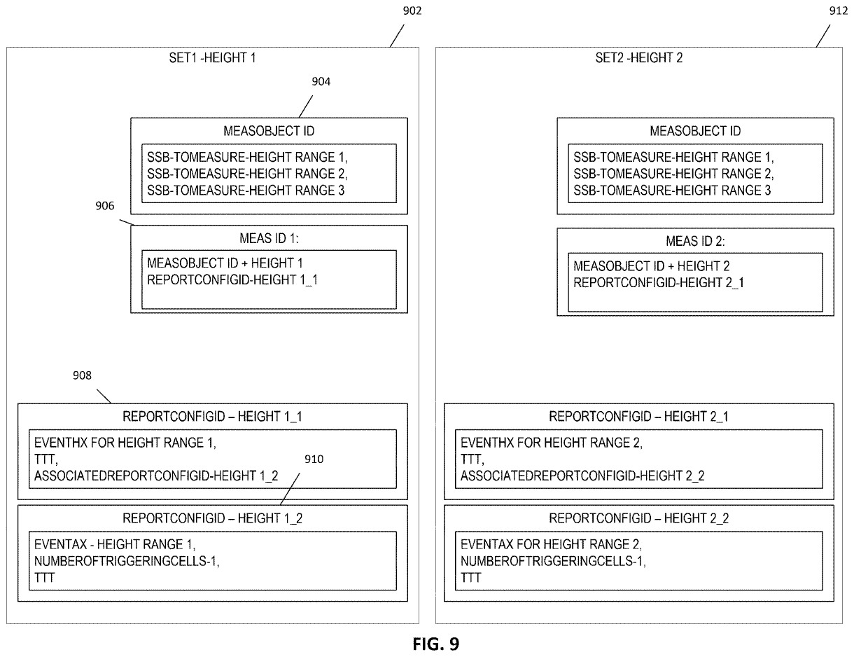

FIG. 9 illustrates an example of configuration information that may be provided from a network to a UE for multiple heights where a report configuration includes an association to a second report configuration, according to some aspects. FIG. 9 shows two sets of RRM configuration data that may be provided from the network to the UE through RRM signaling, in some examples. Such signaling may support multiple RRM configurations to UE for multiple height ranges with signaling that associates two or more report events with each other.

In FIG. 9, multiple sets combine two reporting triggers. A set may include one measID. Each measID may include one MeasObject and one ReportConfigID. The associated measID (#1) may be added into the ReportConfig of the other measID (#2).

For example, the RRM information 902 may include a single measurement ID 906 comprising an association with measurement object ID 904 and a first report configuration ID 908. The first report configuration ID 908 may include the height event and an association (e.g., ‘ASSOCIATEDREPORTCONFIGID’) to a second report configuration ID 910. The second report configuration ID 910 includes the signal quality event. In such a manner, the height event and signal quality event may be coupled together in RRM 902. An association may refer to a value, an ID, a pointer, or other data component that may provide a link between RRM data.

The structure may be duplicated for other RRM data such as 912, which may correspond to a different height range.

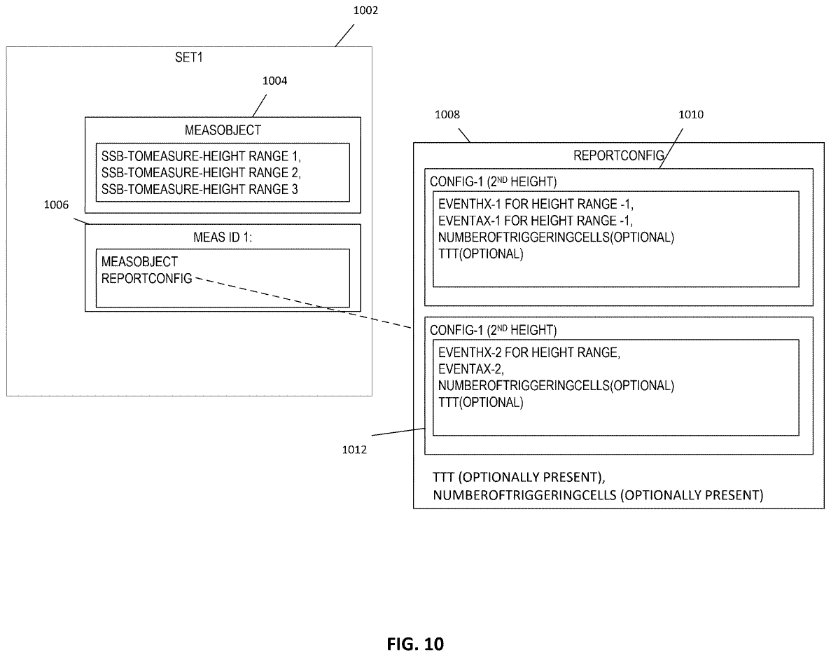

FIG. 10 illustrates an example of configuration information that may be provided from a network to a UE for multiple heights where a report configuration includes an association to a second report configuration, according to some aspects. FIG. 10 shows two sets of RRM configuration data that may be provided from the network to the UE through RRM signaling, in some examples. Such signaling may support multiple RRM configurations to UE for multiple height ranges with signaling that associates two or more report events with each other.

In FIG. 10, multiple sets combine two reporting triggers. In a set, one report configuration contains two or more triggering. Each configuration associates with one report configuration and each report config contains two triggering events. In each set, one AX event is associated with a certain height range. In MeasObject, multiple SSB-ToMeasure are configured for multiple height ranges. For each reporting with one certain height range, UE refers to the corresponding SSB-ToMeasure set.

For example, the RRM information 1002 may include a measurement object 1004, and a report configuration 1008 (e.g., associated with measurement ID 1006). The report configuration 1008 may include a first configuration 1010 comprising the height event and the signal quality event corresponding to a first height range. Further, the report configuration 1008 may include a second configuration 1012 comprising a second height event and a second signal quality event which may correspond to a second height range different from the first height range.

In another option to support multiple RRM configurations to UE for multiple height ranges with signaling that associates two or more report events with each other, multiple sets are identified with multiple measurement ID(s). Each measurement ID associates with one report configuration, and associate with the same measurement object. In such an example, two measID(s) are combined together to indicate that those two reporting events are combined, which are associated with the same measurement object. The UE may be configured recognize that a set includes multiple measure IDs and, in response, combine the criteria in the measure IDs for triggering report measurement in a given height range. This may be referred to as implied association of measurement IDs.

For example, the UE may determine that the RRM information comprises i) a first measurement ID comprising the height event and ii) a second measurement ID comprising the signal quality event. In response, the UE may assume that these events are to both be satisfied in order to trigger the measurement report.

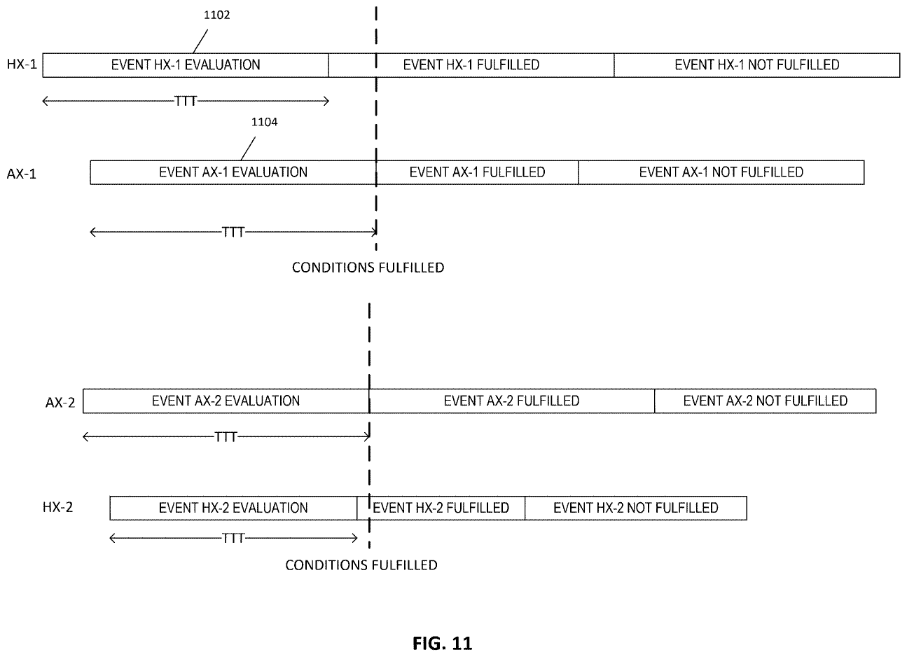

FIG. 11 shows an example diagram of independent event triggering, according to some aspects.

This example shows independent event triggering. Event trigger is independently performed on event AX and HX at blocks 1102, 1104, respectively. UE may add the cell (corresponding to the measurement) into a cellsTriggeredList when both conditions are met for respective TTT. UE may remove the concerned cell from cellsTriggeredList when either condition is not met any more. UE may initiate the measurement reporting if the number of cells in the cellsTriggeredList is larger than or equal to numberOfTriggeringCells.

Generally, when a measurement report is triggered, the UE may put the corresponding cell on a triggered list. The UE may perform other measurement report operations (e.g., additional measurements, etc.) for the cells on the triggered list and generate a measurement report with these cells on the list when the measurement report is triggered.

To determine that the height event and the signal quality event are satisfied, the UE may independently determine that the height event is satisfied for a first time to trigger (at block 1102). Independently (e.g., regardless of the operation at block 1102), the UE may determine, at block 1108, that the signal quality event is satisfied for a second time to trigger. In response, the UE may deem that the events are satisfied and trigger a measurement report for the network (e.g., for a given cell).

As shown in FIG. 11, the order of evaluation of event AX and event HX may vary. Regardless of which is evaluated and satisfied first, the UE must deem that both are satisfied in order to trigger a measurement report.

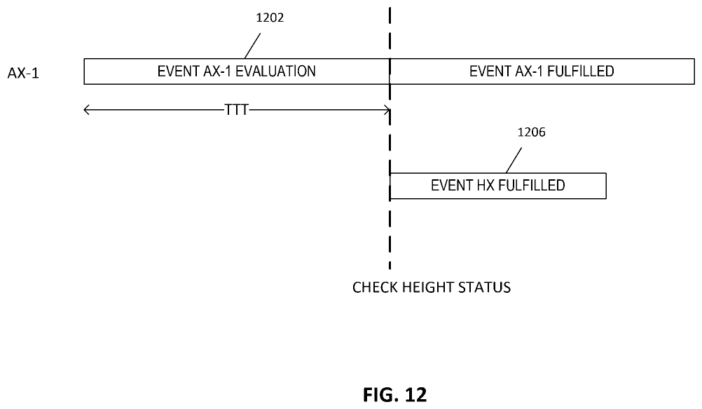

FIG. 12 shows an example diagram of joint event triggering, according to some aspects. A UE may determine that the height event and the signal quality event are satisfied in a joint manner. For example, the UE may determine that, at block 1202 i) the signal quality event is satisfied for a first time to trigger. The UE may proceed to block 1204 and check the height status of the UE. If the height of the UE satisfies the height event instantaneously (e.g., at that instant in time), the height event may be deemed to be satisfied without a second time to trigger, and both events may be deemed to be satisfied.

Under a first example, when AX-1 is met for a cell, UE determines if it locates in the corresponding height range. If yes, UE includes the concerned cell into cellsTriggeredList. If either condition (event AX or height status) is not met any more for the concerned cell, UE removes the concerned cell from cellsTriggeredList. The UE initiates the measurement reporting if the number of cells in the cellsTriggeredList is larger than or equal to numberOfTriggeringCells.

Under a second example, when HX-1 is met for a cell, UE determines if signal quality is in the range of AX. If the signal quality event (AX) is satisfied, the UE may include that cell into a cell list (e.g., cellsTriggeredList).

It should be understood that for examples described in the present disclosure, AX-1 may refer to any one of events A1-A6, and that AX-1 is associated with a first height range. For example, A2-1 may indicate that UE should trigger a report event and report the measurement report in response to the A2 triggering conditions being satisfied at the first height range. Similarly, A3-2 may indicate that UE should trigger a report event and report the measurement report to the network in response to the A3 triggering conditions being satisfied at height range 2.

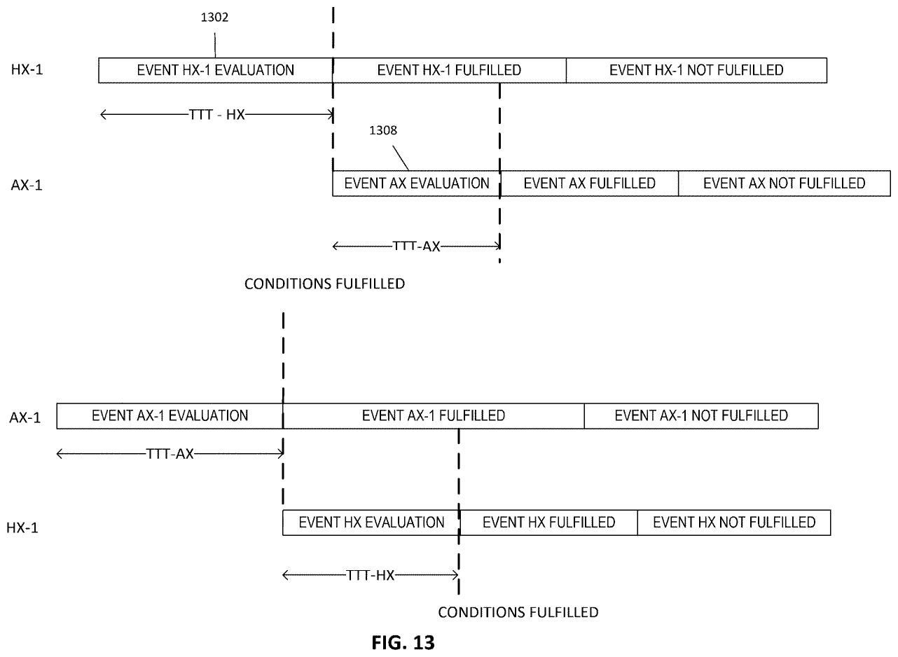

FIG. 13 shows an example diagram of subsequent event triggering, according to some aspects. Determining that the height event and the signal quality event are satisfied may include determining (at block 1302) that a first one of the signal quality event or the height event satisfies a respective time to trigger. In response to the first one satisfying the respective time to trigger, the UE may proceed to block 1308 to determine whether the second one of the signal quality event or the height event satisfies a second time to trigger. If, however, the first event is not satisfied, the UE may refrain from evaluating whether the second event is satisfied.

For example, with the subsequent event triggering behavior, a UE only starts evaluating HX (or AX) event when UE conditions satisfy the AX (or HX) event for TTT-AX (TTT-HX). If the UE conditions depart from (no longer satisfy) the AX (or HX) event during respective time to trigger, the UE stops performing HX (or AX) evaluation. If UE conditions satisfy the second AX (or HX) event during TTT-HX (or TTT-AX) for first AX (or HX) event, UE stops evaluating the first HX (or AX) event.

When both events are satisfied for the relevant time to trigger, UE includes the concerned cell into cellsTriggeredList. If either condition is not met anymore, UE removes the concerned cell from cellsTriggeredList.

As described, the UE may initiate the measurement reporting if the number of cells in the cellsTriggeredList is larger than or equal to numberOfTriggeringCells.

In one aspect, UE behavior upon height change (e.g., from a first height range to a second height range) is described. In particular, one or more operations performed by the UE may determine how to deal with measurement data in view of height change.

Generally, a UE starts measuring on the new beams and performs report event evaluation based on new configurations, such as those configurations described. In one example, in layer 1 (L1) handling: If the beam index(s) to measure are changed (due to height change), UE may clear the L1 samples previously collected. These L1 samples may include, for example, SINR, RSRP, and/or RSRQ samples.

In one example, the UE may perform layer 3 (L3) measurement filtering of SINR, RSRP, RSRQ measurements. The UE may keep these previous measurements without clearing them. Alternatively, in response to a height range change, the UE may clear previous L3 results. For example, the UE may keep each and every L3 measurement result from the previous height range.

In one example, for the cells already contained in the UE's cellsTriggeredList, the UE may re-evaluate if those cells satisfy the criteria of the new events and remove only those cells that do not satisfy the criteria. Alternatively, the UE may clear the variant, or all the cells contained in the list.

In one aspect, the coordination of beam indexes is performed between UE and network. In a first example, without coordination, network uses the union of configured SSB-ToMeasure(s) for scheduling determination. In a second example, to improve scheduling at network, UE could send a MAC CE once the measured beam index(s) are changed due to height change.

In one example, the UE may send to the network, an indication of a reference signal (e.g., an SSB index or CSI-RS index) that the UE is currently measuring. The network may schedule usage of resources (e.g., the available reference signals) around the reference signal, in response to receiving the indication from the UE. The used reference signal is not allocated for other purposes while the UE is measuring it. The indication may be sent using a measurement object ID with a reference signal index or a height range index, which may be sent in a media access control (MAC) control element (CE) signal.

If the network has knowledge of the exact SSB index that the UE is measuring, the network can better schedule the UE by avoiding usage of those SSB symbols (and some symbols beforehand for UE RF retuning). For example, when UE is at height 1: the UE may be configured to measure SSB index 1, 3, or both. When UE is at height 2: the UE may be configured to measure SSB index 2.

Generally, a MAC CE may be introduced for the UE to indicate the current beams that the UE is to measure. As described, the MAC CE may indicate i) MeasObject ID+SSB index(s), or ii) MeasObject ID+height range index.

Various aspects and examples described with respect to a UE are also extendable to a network (e.g., a base station). For example, in one aspect, method is performed by a network in a 5G new radio (NR) environment. The method comprises sending a radio resource management (RRM) information to a user equipment (UE), the RRM information comprising a height event that is associated with a height range and a signal quality event that is associated with said height range, wherein the UE is configured to perform a measurement of the network based on a current height of the UE and the RRM information, and in response to at least the height event and the signal quality event being satisfied, generate a measurement report and send the measurement report to the network; and receiving the measurement report from the UE.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

A baseband processor (also known as baseband radio processor, BP, or BBP) is a device (a chip or part of a chip) in a network interface that manages radio functions, such as communicating (e.g., TX and RX) over an antenna.

An article of manufacture may be used to store program code. An article of manufacture that stores program code may be embodied as, but is not limited to, one or more memories (e.g., one or more flash memories, random access memories (static, dynamic, or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “transmitting”, “sending”, “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary aspects of the present invention. One skilled in the art will readily recognize from such discussion, the accompanying drawings and the claims that various modifications can be made without departing from the spirit and scope of the invention.

What is claimed is:

1. A method for wireless communication by a user equipment (UE), comprising:
receiving a radio resource management (RRM) information from a network, the RRM information comprising a height event that is associated with a height range and a signal quality event that is associated with said height range;
performing a measurement of the network based on a current height of the UE and the RRM information; and
in response to at least the height event and the signal quality event being satisfied, generating a measurement report and sending the measurement report to the network.

2. The method of claim 1, wherein the RRM information comprises a first measurement identifier (ID) and a second measurement ID,
wherein the first measurement ID is associated with a measurement object ID and a first report configuration ID comprising the height event and an association with the second measurement ID, and
wherein the second measurement ID is associated with said measurement object ID and a second report configuration comprising the signal quality event and a second association with the first measurement ID.

3. The method of claim 1, wherein the RRM information comprises a single measurement ID comprising a measurement object ID, a first report configuration ID comprising the height event, and a second report configuration ID comprising the signal quality event.

4. The method of claim 1, wherein the RRM information comprises a single measurement ID comprising a measurement object ID and a first report configuration ID, wherein the first report configuration ID comprises the height event and an association to a second report configuration ID that comprises the signal quality event.

5. The method of claim 1, wherein the RRM information comprises:
a measurement object, and a report configuration, wherein the report configuration comprises
a first configuration comprising the height event and the signal quality event, and
a second configuration comprising a second height event and a second signal quality event.

6. The method of claim 1, wherein the RRM information comprises a measurement object ID that comprises a plurality of height ranges and corresponding reference signal to measure for a respective one of the plurality of height ranges.

7. The method of claim 1, wherein performing the measurement of the network based on the current height of the UE and the RRM information comprises determining that the RRM information comprises i) a first measurement ID comprising the height event and ii) a second measurement ID comprising the signal quality event.

8. The method of claim 1, wherein the RRM information comprises a time to trigger for the height event and a second time to trigger for the signal quality event.

9. The method of claim 1, wherein the RRM information comprises a number of triggering cells associated with the height event or with the signal quality event.

10. The method of claim 1, wherein determining that the height event and the signal quality event are satisfied comprises independently determining that i) the height event is satisfied for a first time to trigger, and ii) the signal quality event is satisfied for a second time to trigger.

11. The method of claim 1, wherein determining that the height event and the signal quality event are satisfied comprises determining that i) the signal quality event is satisfied for a first time to trigger, and ii) the height event is satisfied instantaneously without a second time to trigger.

12. The method of claim 1, wherein determining that the height event and the signal quality event are satisfied comprises determining that one of the signal quality event or the height event satisfies a first time to trigger, and in response to the one satisfying the first time to trigger, determining another of the signal quality event or the height event satisfies a second time to trigger.

13. The method of claim 1, wherein in response to the UE leaving the height range, the UE clears a layer 1 sample associated with the measurement of the network associated with the height range.

14. The method of claim 13, wherein in response to the UE leaving the height range, the UE does not clear layer 3 measurements of the network.

15. The method of claim 13, wherein in response to the UE leaving the height range, the UE re-evaluates if cells that previously satisfied a respective signal quality event and respective height event still satisfy the respective signal quality event and respective height event.

16. The method of claim 13, wherein in response to the UE leaving the height range, the UE clears any cell that previously satisfied a respective signal quality event and height event.

17. The method of claim 1, further comprising sending, to the network, an indication of a reference signal that the UE is currently measuring, wherein the network schedules around the reference signal in response to receiving the indication from the UE.

18. The method of claim 17, wherein sending the indication comprises sending a measurement object ID with a reference signal index or a height range index in a media access control (MAC) control element (CE) signal.

19. (canceled)

20. A user equipment (UE), comprising:
a processor, coupled to computer-readable memory storing instructions that, when executed by the processor, cause the processor to:
receive a radio resource management (RRM) information from a network, the RRM information comprising a height event that is associated with a height range and a signal quality event that is associated with said height range;
performing a measurement of the network based on a current height of the UE and the RRM information; and
in response to at least the height event and the signal quality event being satisfied, generating a measurement report and sending the measurement report to the network.

21. A non-transitory computer-readable storage medium, comprising instructions that, when executed by one or more processors of a user equipment (UE), cause the UE to:
receive a radio resource management (RRM) information from a network, the RRM information comprising a height event that is associated with a height range and a signal quality event that is associated with said height range;
perform a measurement of the network based on a current height of the UE and the RRM information; and
in response to at least the height event and the signal quality event being satisfied, generate a measurement report and send the measurement report to the network.
